(19) United States
(12) Patent Application Publication
(10) Pub. No.: US 2008/0076296 A1
(43) Pub. Date: Mar. 27, 2008

(54) TRANSFORMER WITH A CONNECTOR

(75) Inventors: Cheng-Chia Hsu, Chubei City (TW); Yun-Ching Wu, Hsinchu (TW)

Correspondence Address: PAI PATENT & TRADEMARK LAW FIRM, 1001 FOURTH AVENUE, SUITE 3200, SEATTLE, WA, 98154, US

(73) Assignee: LOGAH TECHNOLOGY CORP., Chubei City (TW)

(21) Appl. No.: 11/535,982

(22) Filed: Sep. 27, 2006

(51) Int. Cl. H01R 13/66

(52) U.S. Cl. 439/541.5

(57) ABSTRACT

A transformer with a connector is described, having a primary side and a secondary side and composed of a winding base, a core and windings, wherein the core is inserted into the winding base and the windings are wound on the winding base, and the transformer is characterized in that a connector is disposed at the secondary side of the transformer and connected to an external connector disposed at a load to which a signal fed through the primary side to the transformer is outputted when the connector and the external connector are connected to each other. In the transformer, the connector conventionally disposed on the circuit board is disposed on the transformer, saving the space that would otherwise be needed for connection wires between the transformer and the connector. Therefore, the circuit board has a reduced area, effectively saving the manufacturing cost for a product to which the circuit board is applied.

### BACKGROUND OF THE INVENTION

1. Field of the Invention

The present invention relates to a transformer with a connector, and particularly to a transformer with a connector applied onto a circuit board for liquid crystal device (LCD) backlight source.

2. Description of the Prior Art

Referring to FIG. 1, a schematic diagram of a circuit board for a conventional liquid crystal device (LCD) backlight source having a transformer thereon is shown therein. As shown, on the circuit board 2 for the LCD backlight source having a transformer 1, an input signal is fed into a primary side 11 of the transformer 1. After being processed in the transformer 1, the input signal is transformed into an output signal at a secondary side 12. The output signal is connected with a connector 31 located at a side of the circuit board 2 via connection wires 21 arranged on the circuit board 2. The connector 31 is disposed for connection with an external connector 32 at a load end. As such, the output signal as mentioned is supplied to a load 4.

Although the above mentioned arrangement may achieve the purposes of signal conversion and transmission, the following drawbacks still exist: (1) Since the LCD product is becoming lighter and more compact, it is necessary to make the circuit board for the LCD backlight source relatively smaller. However, the transformer, connection wires, connectors and the like will take up a large portion of the circuit board. In this regard, there is a need to redesign the transformer, connection wires, connectors and the like on the circuit board. (2) Since the LCD product has become a mainstream, how to reduce the manufacturing cost has become more and more important. Therefore, the present invention is directed to how to redesign the transformer and thus reduce the dimension of the circuit board for the LCD backlight source.

To solve these problems, the inventors of the present invention have made a lot of effort and finally set forth a transformer with a connector, which is the subject of the present invention.

### SUMMARY OF THE INVENTION

It is, therefore, an object of the present invention to provide a transformer with a connector in which the connectors are arranged on the transformer in such a way as to save room required for connection for the connectors with wires, thus considerably reducing the dimension of a circuit board on which the transformer is disposed.

It is another object to provide a transformer with a connector, in which the connectors of different types, forms and specifications can be flexibly disposed at proper locations at a secondary side of the transformer, according to the characteristics and requirements of a circuit board on which the transformer is disposed.

It is still another object to provide a transformer with a connector, which not only can reduce the area of a circuit board on which the transformer is disposed and therefore the manufacturing cost for the transformer itself, but also has the advantages in terms of easier manufacturing process, better stability, prolonged lifetime and smaller total space.

According to the present invention, the transformer with a connector has a primary side and a secondary side and is composed of a winding base, a core and windings, wherein the core is inserted into the winding base and the windings are wound on the winding base. The transformer is characterized in that a connector is disposed at the secondary side of the transformer and connected to an external connector disposed at a load to which a signal fed through the primary side to the transformer is outputted when the connector and the external connector are connected to each other. In the transformer, the connector conventionally disposed on the circuit board is disposed on the transformer, saving the space that would otherwise be needed for connection wires between the transformer and the connector. Therefore, the circuit board has a reduced area, effectively saving the manufacturing cost for a product to which the circuit board is applied.

### BRIEF DESCRIPTION OF THE DRAWINGS

The drawings disclose illustrative embodiments of the present invention which serve to exemplify the various advantages and objects hereof, and are as follows:

FIG. 1 is a schematic diagram of a circuit board for a liquid crystal device (LCD) backlight source having a conventional transformer thereon;

FIG. 2 is a schematic diagram of a circuit board for LCD backlight source having a transformer with a connector according to a first embodiment of the present invention;

FIG. 3A is a schematic diagram of the transformer with a connector according to a first form of the first embodiment of the present invention;

FIG. 3B is a schematic diagram of the transformer with a connector according to a second form of the first embodiment of the present invention;

FIG. 3C is a schematic diagram of the transformer with a connector according to a third form of the first embodiment of the present invention;

FIG. 3D is a schematic diagram of the transformer with a connector according to a fourth form of the first embodiment of the present invention;

FIG. 4 is a schematic diagram of the transformer with a connector according to a fifth form of the first embodiment of the present invention;

FIG. 5A is a schematic diagram of the transformer with a connector according to a sixth form of the first embodiment of the present invention;

FIG. 5B is a schematic diagram of the transformer with a connector according to a seventh form of the first embodiment of the present invention;

FIG. 6A is a schematic diagram of a circuit board for LCD backlight source having the transformer with a connector according to a second embodiment of the present invention;

FIG. 6B is a schematic diagram of the circuit board for LCD backlight source having the transformer with a connector according to another form of the second embodiment of the present invention;

FIG. 7A is a structural diagram of the transformer with a connector according to a first form of the second embodiment of the present invention;

FIG. 7B is a side view of the structural diagram of the transformer shown in FIG. 7A;

FIG. 7C is a structural diagram of the transformer with a connector according to a second form of the second embodiment of the present invention;

FIG. 7D is a side view of the structural diagram of the transformer shown in FIG. 7C;

FIG. 8A is a schematic diagram of the transformer with a connector according to a third form of the second embodiment of the present invention; and

FIG. 8B is a schematic diagram of the transformer with a connector according to a fourth form of the second embodiment of the present invention.

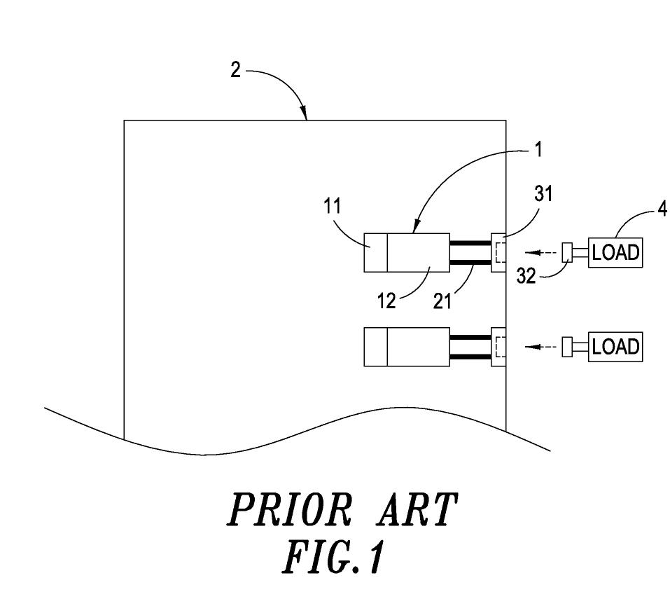

### DETAILED DESCRIPTION OF THE PREFERRED EMBODIMENT

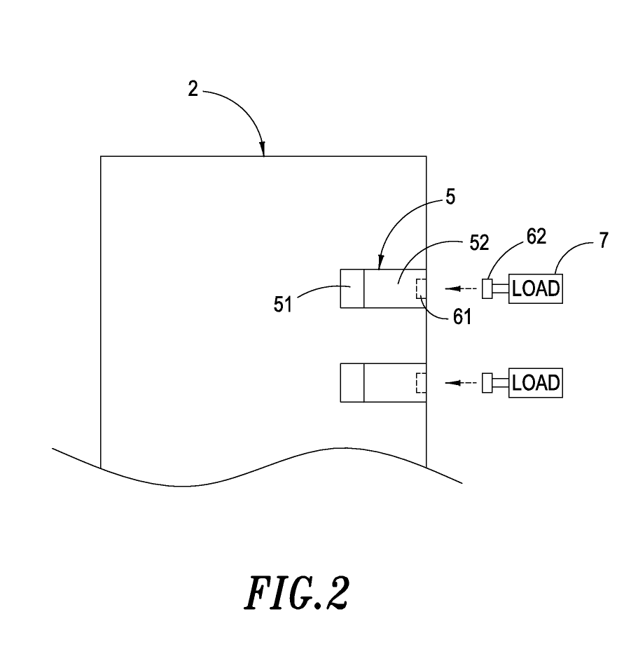

In FIG. 2, a schematic diagram of a circuit board for liquid crystal device (LCD) backlight source having a transformer with a connector according to a first embodiment of the present invention is depicted. As shown, on the circuit board 2, an input signal is fed into a primary side 51 of the transformer 5. Then, an output signal is obtained at a secondary side 52 of the transformer 5 in response to the input signal. On the secondary side 52 of the transformer 5, a connector 61 is disposed. At a load end, an external connector 62 is connected. When the connector 61 and the external connector 62 are connected to each other, the output signal of the transformer 5 can be supplied to the load 7.

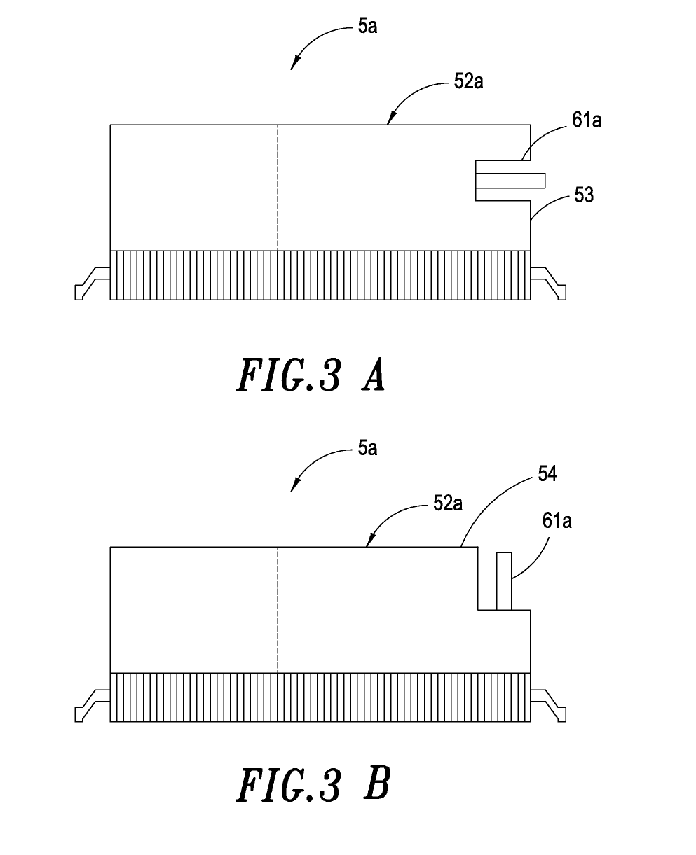

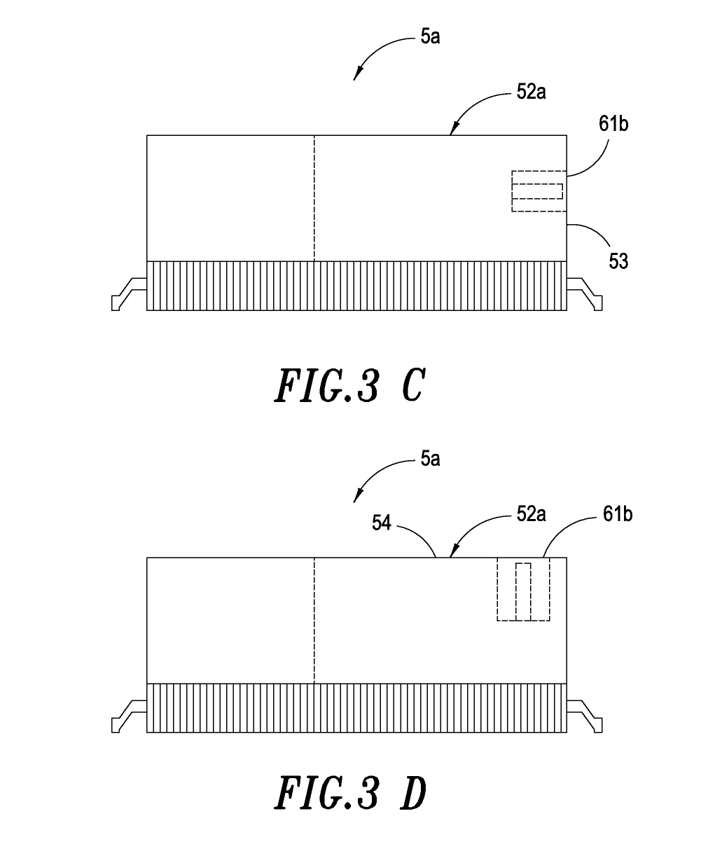

In FIG. 3A, a schematic diagram of the transformer with a connector according to a first form of the first embodiment of the present invention is depicted. As shown, the transformer 5a is composed of a winding base, a core, windings and a connector 61a. The core is inserted into the winding base. The windings are wound on the winding base. The transformer 5a takes the form of EE type core transformer. The connector 61a is disposed at a side surface 53 of the winding base at a secondary side 52a of the transformer 5a. The connector 61a takes a form of protrusion for connection with an external connector. In this manner, the output signal of the transformer 5a can be supplied to the load of the transformer 5a.

In FIG. 3B, a schematic diagram of the transformer with a connector according to a second form of the first embodiment of the present invention is depicted. As shown, the transformer 5a is composed of a winding base, a core, windings and a connector 61a. The core is inserted into the winding base. The windings are wound on the winding base. The transformer 5a takes the form of EE type core transformer. The connector 61a is disposed at an upper side surface 54 of the winding base at the secondary side 52a of the transformer 5a. The connector 61a takes a form of protrusion for connection with an external connector. In this manner, the output signal of the transformer 5a can be supplied to the load of the transformer 5a.

In FIG. 3C, a schematic diagram of the transformer with a connector according to a third form of the first embodiment of the present invention is depicted. As shown, the transformer 5a is composed of a winding base, a core, windings and a connector 61b. The core is inserted into the winding base. The windings are wound on the winding base. The transformer 5a takes the form of EE type core transformer. The connector 61b is disposed at a side surface 53 of the winding base at the secondary side 52a of the transformer 5a. The connector 61b takes a form of indentation for connection with an external connector. In this manner, the output signal of the transformer 5a can be supplied to the load of the transformer 5a.

In FIG. 3D, a schematic diagram of the transformer with a connector according to a fourth form of the first embodiment of the present invention is depicted. As shown, the transformer 5a is composed of a winding base, a core, windings and a connector 61b. The core is inserted into the winding base. The windings are wound on the winding base. The transformer 5a takes the form of EE type core transformer. The connector 61b is disposed at an upper side surface 54 of the winding base at the secondary side 52a of the transformer 5a. The connector 61b takes a form of indentation for connection with an external connector. In this manner, the output signal of the transformer 5a can be supplied to the load of the transformer 5a.

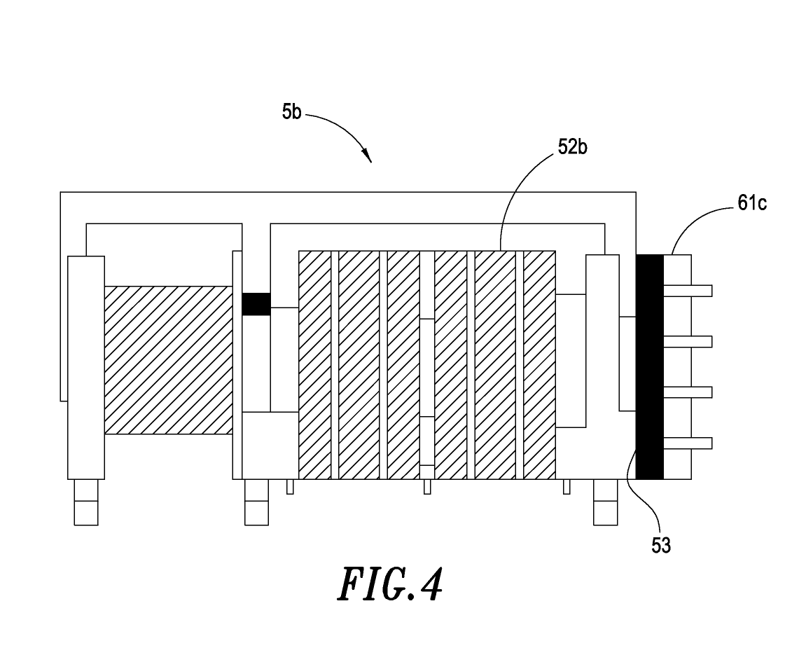

In FIG. 4, a schematic diagram of the transformer with a connector according to a fifth form of the first embodiment of the present invention is depicted. As shown, the transformer 5b is composed of a winding base, a core, windings and a connector 61c. The core is inserted into the winding base. The windings are wound on the winding base. The transformer 5b takes the form of CI type core transformer. The connector 61c is disposed at a side surface 53 of the winding base at the secondary side 52b of the transformer 5b. The connector 61c takes a form of protrusion for connection with an external connector. In this manner, the output signal of the transformer 5a can be supplied to the load of the transformer 5a.

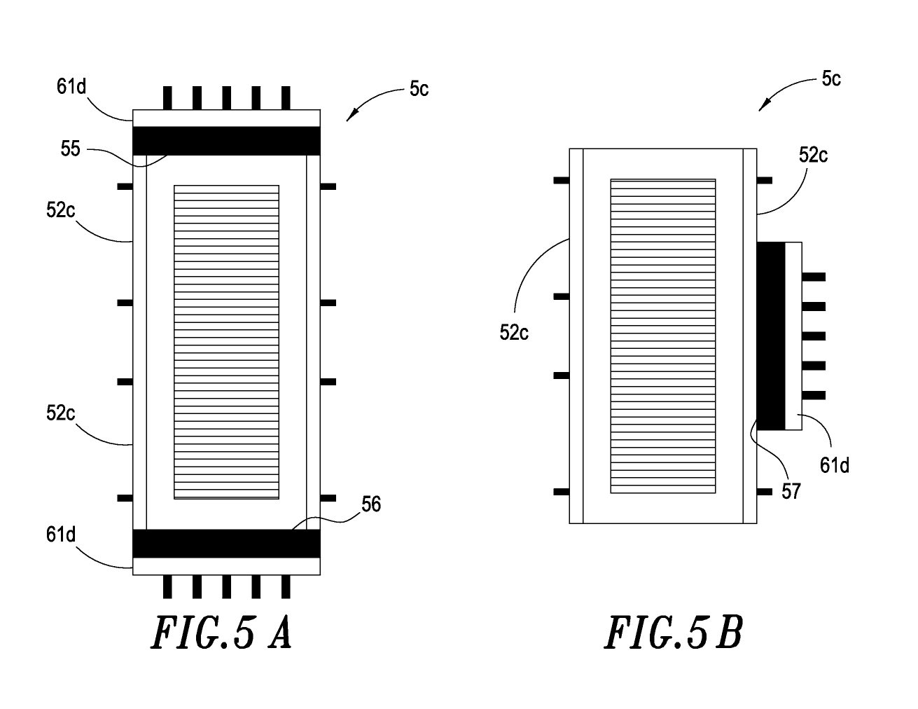

In FIG. 5A, a schematic diagram of the transformer with a connector according to a sixth form of the first embodiment of the present invention is depicted. As shown, the transformer 5c is composed of a winding base, a core, windings and a connector 61d. The core is inserted into the winding base. The windings are wound on the winding base. The transformer 5c takes the form of EI type core transformer and has a single input and two outputs. Since there are two outputs at the secondary side 52c of the transformer 5c, a connector 61d is disposed at each of two sides 55, 56 of the winding base of the transformer 5c. Each of the connectors 61d takes a form of protrusion for connection with an external connector. In this manner, the output signal of the transformer 5c can be supplied to two loads of the transformer 5c.

In FIG. 5B, a schematic diagram of the transformer with a connector according to a seventh form of the first embodiment of the present invention is depicted. As shown, the transformer 5c is composed of a winding base, a core, windings and a connector 61d. The core is inserted into the winding base. The windings are wound on the winding base. The transformer 5c takes the form of EI type core transformer and has a single input and two outputs. Since there are two outputs at the secondary side 52c of the transformer 5c, a connector 61d is disposed at a side surface 57 of the winding base of the transformer 5c, respectively. The connectors 61d takes a form of protrusion for connection with an external connector. In this manner, the output signal of the transformer 5c can be supplied to two loads of the transformer 5c.

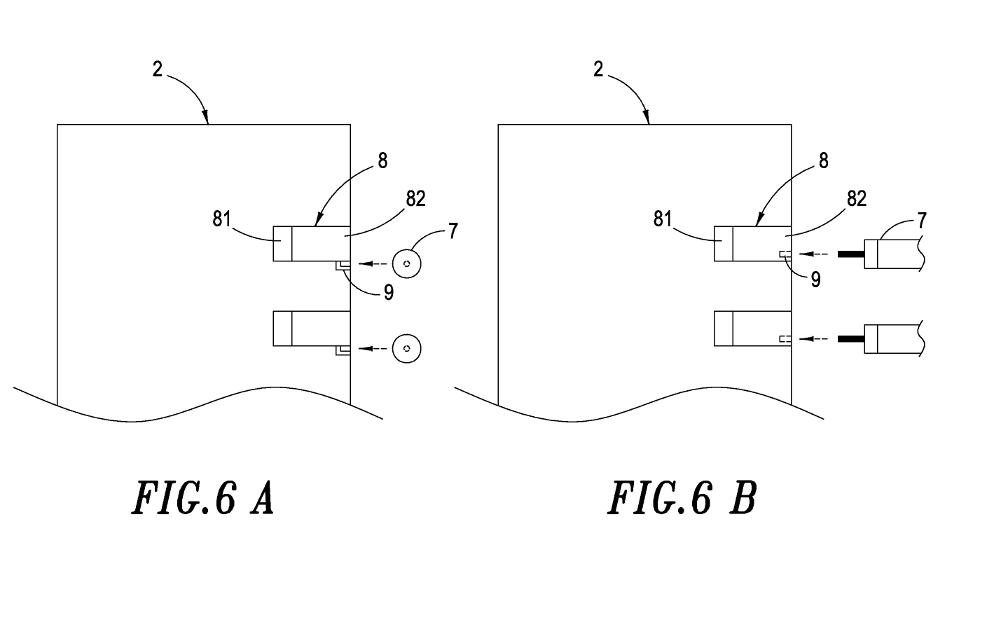

In FIG. 6A and FIG. 6B, schematic diagrams of a circuit board for LCD backlight source having the transformer with the connector according to two forms of a second embodiment of the present invention are respectively depicted. As shown, on the circuit board 2, an input signal is fed into a primary side 81 of the transformer 8. Then, an output signal is obtained at a secondary side 82 of the transformer 8 in response to the input signal. On the secondary side 82 of the transformer 8, a connector 9, in which a resilient piece or a conductive rubber is provided, is disposed. The connector 9 may be connected directly to a load (e.g. a lamp) 7 through the resilient piece or the conductive rubber. Through the connector 9, the output signal of the transformer 8 can be supplied to the load 7 in a vertical (e.g. FIG. 6A) or horizontal (e.g. FIG. 6B) direction.

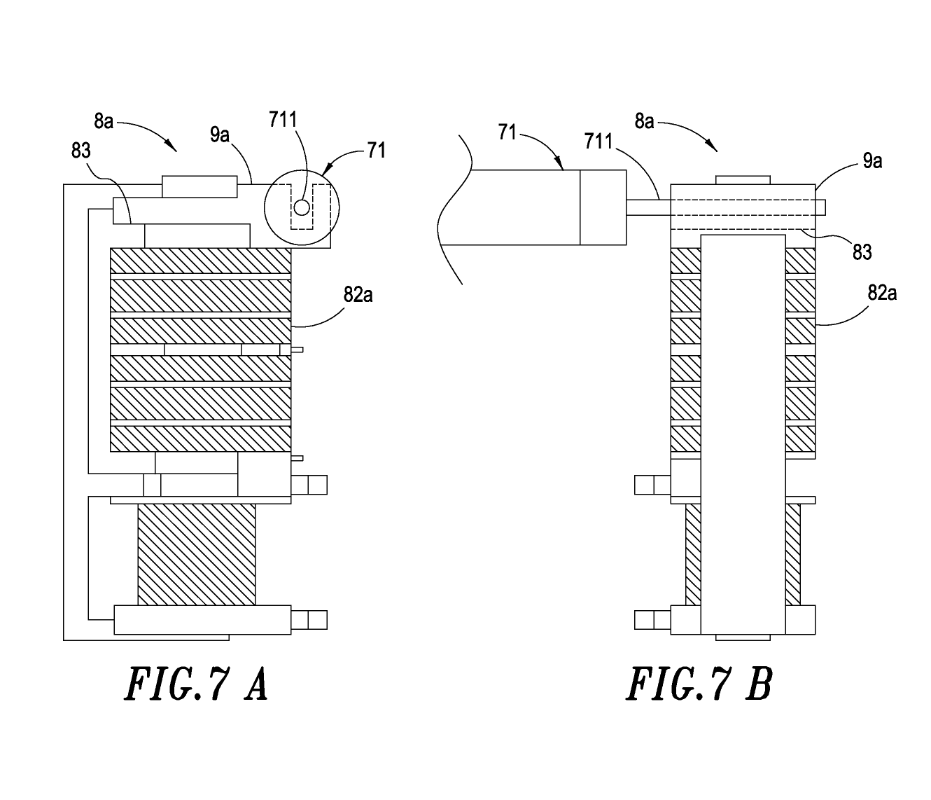

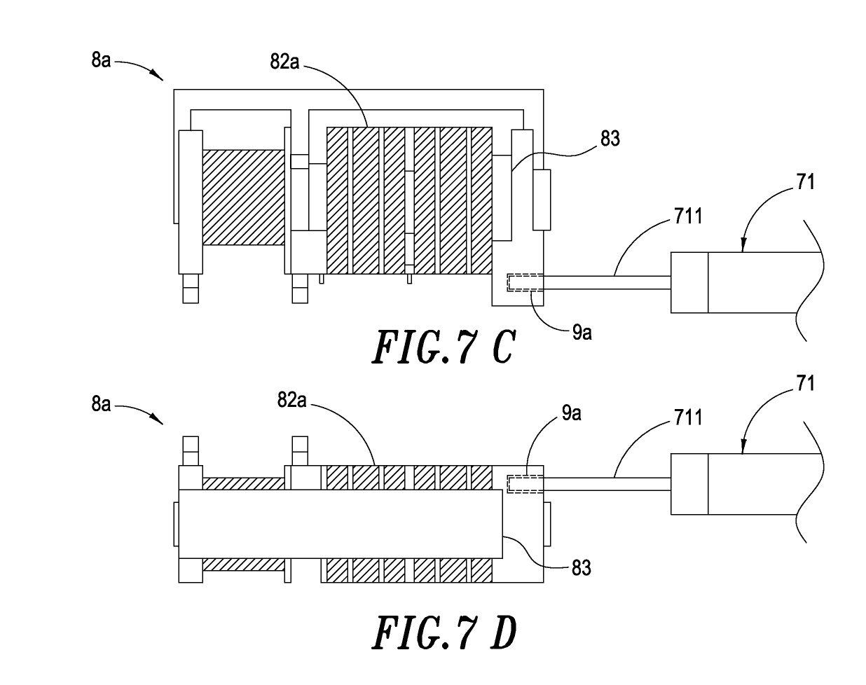

FIG. 7A and FIG. 7B are respectively a structural diagram and a side view of the transformer with a connector according to a first form of the second embodiment of the present invention. As shown, the transformer 8a is composed of a winding base, a core and a connector 9a. The core is inserted into the winding base. The windings are wound on the winding base. The transformer 8a is a CI type core transformer. The connector 9a is disposed at a side 83 of the winding base located at the secondary side 82a of the transformer 8a. The connector 9a takes a form of indentation for a vertical connection with an electrode terminal 711 of a lamp 71, wherein the electrode terminal 711 is vertically inserted into and fixed on the connector 9a. In this manner, the output signal from the transformer 9a can be supplied to the lamp.

FIG. 7C and FIG. 7D are respectively a structural diagram and a side view of the transformer with a connector according to a second form of the second embodiment of the present invention. As shown, the transformer 8a is composed of a winding base, a core and a connector 9a. The core is inserted into the winding base. The windings are wound on the winding base. The transformer 8a is a CI type core transformer. The connector 9a is disposed at a side 83 of the winding base located at the secondary side 82a of the transformer 8a. The connector 9a takes a form of indentation for a vertical connection with an electrode terminal 711 of a lamp 71, wherein the electrode terminal 711 is vertically inserted into and fixed on the connector 9a. In this manner, the output signal from the transformer 9a can be supplied to the lamp 7.

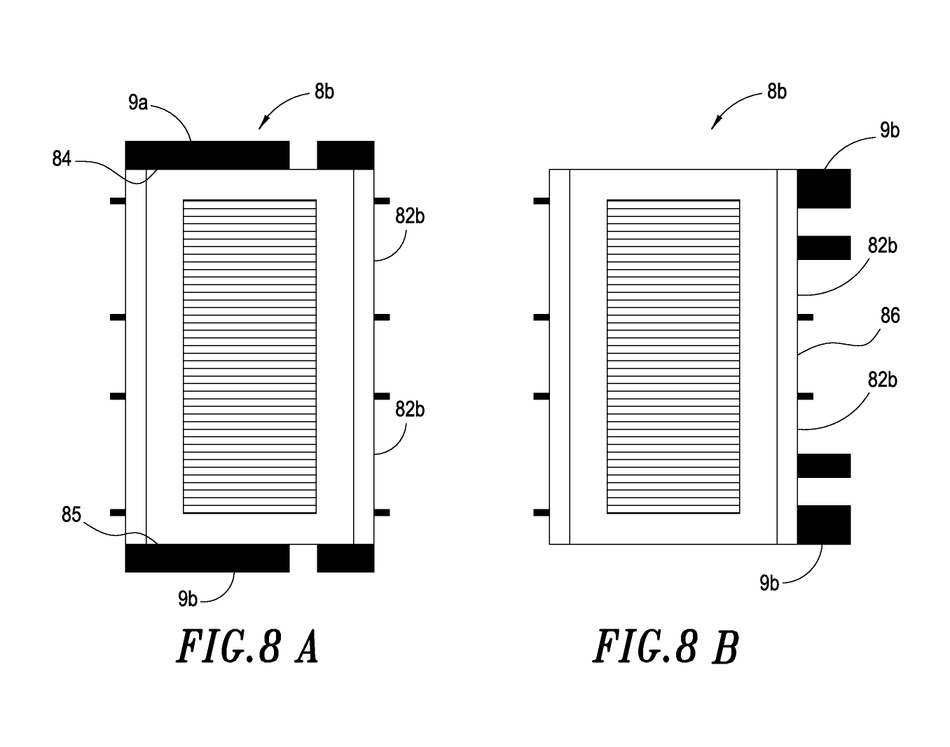

FIG. 8A is a schematic diagram of the transformer with a connector according to a third form of the second embodiment of the present invention. As shown, the transformer 8b is composed of a winding base, a core and a connector 9b. The core is inserted into the winding base. The windings are wound on the winding base. The transformer 8b is an EI type core transformer and has a single input and two outputs. Since the transformer 8b has two secondary sides, two connectors 9b may be respectively disposed at two sides 84,85 of the winding base of the transformer 8b. Each of the connectors 9b takes a form of indentation for a vertical or horizontal connection with an electrode terminal of the lamp, wherein the electrode terminal is vertically or horizontally inserted into and fixed on the connector 9b. In this manner, the output signal from the transformer 9b can be supplied to the lamp.

FIG. 8B is a schematic diagram of the transformer with a connector according to a fourth form of the second embodiment of the present invention. As shown, the transformer 8b is composed of a winding base, a core and a connector 9b. The core is inserted into the winding base. The windings are wound on the winding base. The transformer 8b is an EI type core transformer and has a single input and two outputs. Since the transformer 8b has two secondary sides, two connectors 9b may be respectively disposed at two ends of a side surface 86 of the winding base of the transformer 8b. Each of the connectors 9b takes a form of indentation for a vertical or horizontal connection with an electrode terminal of the lamp, wherein the electrode terminal can be vertically or horizontally inserted into and fixed on the connector 9b. In this manner, the output signal from the transformer 9b can be supplied to the lamp.

As compared to the prior art, the transformer with a connector according to the present invention has the following advantages: (1) Since the connector is disposed on the transformer, the transformer and the connector can be connected without connection wires in between, thus considerably reducing the dimension of the circuit board on which the transformer is disposed. (2) A connector of any form can be used with the transformer according to the characteristics and requirements of the circuit board, the connector being disposed at a proper position at the secondary side of the transformer, resulting in the contemplated forms of transformer in this invention. (3) The transformer of this invention not only can reduce the area of a circuit board on which the transformer is disposed and therefore the manufacturing cost for the transformer itself, but also has the advantages in terms of easier manufacturing process, better stability, prolonged lifetime and smaller total space.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A transformer with a connector, the transformer having a primary side and a secondary side and composed of a winding base, a core and windings, wherein the core is inserted into the winding base and the windings are wound on the winding base, and characterized in that:
the connector is disposed at the secondary side of the transformer and connected to an external connector disposed at a load to which a signal fed through the primary side to the transformer is outputted when the connector and the external connector are connected to each other.

2. The transformer according to claim 1, wherein the transformer is an EE type core transformer.

3. The transformer according to claim 2, wherein the connector takes a form of a protrusion.

4. The transformer according to claim 2, wherein the connector takes a form of an indentation.

5. The transformer according to claim 3, wherein the connector is disposed at a side surface of the winding base located at the secondary side of the transformer.

6. The transformer according to claim 4, wherein the connector is disposed at a side surface of the winding base located at the secondary side of the transformer.

7. The transformer according to claim 3, wherein the connector is disposed at an upper side surface of the winding base located at the secondary side of the transformer.

8. The transformer according to claim 4, wherein the connector is disposed at an upper side surface of the winding base located at the secondary side of the transformer.

9. The transformer according to claim 1, wherein the transformer is a CI type core transformer.

10. The transformer according to claim 8, wherein the connector takes a form of a protrusion.

11. The transformer according to claim 10, wherein the connector is disposed at a side of the winding base located at the secondary side of the transformer.

12. The transformer according to claim 1, wherein the transformer is an EI type core transformer.

13. The transformer according to claim 12, wherein the connector takes a form of a protrusion.

14. The transformer according to claim 13, wherein the connector is disposed at two sides of the winding base located at the secondary side of the transformer.

15. The transformer according to claim 13, wherein the connector is disposed at two ends of a side of the winding base located at the secondary side of the transformer.

16. A transformer with a connector, the transformer having a primary side and a secondary side and composed of a winding base, a core and windings, wherein the core is inserted into the winding base and the windings are wound on the winding base, and characterized in that:
the connector is disposed at the winding base located at the secondary side of the transformer and vertically or horizontally connected to a load so that a signal from the transformer is outputted to the load.

17. The transformer according to claim 16, wherein the transformer is a CI type core transformer.

18. The transformer according to claim 17, wherein the connector takes a form of an indentation.

19. The transformer according to claim 18, wherein the connector is disposed at a side of the winding base located at the secondary side of the transformer.

20. The transformer according to claim 16, wherein the transformer is an EI type core transformer.

21. The transformer according to claim 20 wherein the connector takes a form of an indentation.

22. The transformer according to claim 21, wherein the connector is disposed at two sides of the winding base located at the secondary side of the transformer.

23. The transformer according to claim 22, wherein the connector is disposed at two ends of a side of the winding base located at the secondary side of the transformer.

24. The transformer according to claim 16, wherein the load is a lamp.

25. The transformer according to claim 16, wherein a resilient piece or a conductive rubber is disposed in the connector.
